(19) United States
(12) Patent Application Publication
(10) Pub. No.: US 2024/0100655 A1
(43) Pub. Date: Mar. 28, 2024

(54) PLIERS WITH MULTIPLE BITE ADJUSTMENT OPTIONS

(71) Applicant: Apex Brands, Inc., Apex, NC (US)

(72) Inventor: Zhihong Fu, Cary, NC (US)

(21) Appl. No.: 18/267,843

(22) PCT Filed: Dec. 14, 2021
(86) PCT No.: PCT/US2021/063242

§ 371 Date: Jun. 16, 2023

Related U.S. Application Data
(60) Provisional application No. 63/127,472, filed on Dec. 18, 2020.

(51) Int. Cl. B25B 7/12; B25B 7/16; B25B 7/18

(52) U.S. Cl. CPC B25B 7/123; B25B 7/16; B25B 7/18

(57) ABSTRACT

A hand tool includes a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be configured to enable a grip size defined by the jaw assembly to be modified and includes a first adjuster disposed at a distal end of the top handle, a second adjuster disposed at a point between a middle portion and proximal end of the top handle, and an adjustment rod operably coupled to each of the first and second adjusters.

### TECHNICAL FIELD

Example embodiments generally relate to hand tools and, in particular, relate to a pliers that can be easily adjusted due to the provision of multiple adjustment options.

### BACKGROUND

Hand tools are commonly used across all aspects of industry and in the homes of consumers. Hand tools are employed for multiple applications including, for example, tightening, component joining, and/or the like. For some applications, a locking pliers may be preferred. These familiar hand tools typically include jaws that can be locked into position after passing an over-center or other balance or tipping point position. In this regard, the jaws can effectively be locked in a clamping position and will remain closed in the clamping position after being locked until some unlocking action or force is initiated.

Modern conventional locking pliers often include an adjustment assembly, which enables the distance between the top and bottom jaws when the pliers is locked to be adjusted. The adjustment is conventionally made via a screw that is located at a distal end of the top handle (relative to the jaws). In this regard, the adjusting screw extends out of the distal end of the top handle and must be adjusted either when no gripping action is taking place or, if during a gripping action, by the hand opposite the hand engaging the locking pliers for the gripping action. Since it is not uncommon for users to attempt to size the distance between jaws dynamically while preparing to engage in a gripping operation, using two hands to adjust the locking pliers effectively becomes almost a rule.

In addition to being more complicated, two-hand operation of the locking pliers may be impractical for certain operations (e.g., where the operator needs to hold another piece of equipment or a pipe or component that is to be gripped with the locking pliers). Nevertheless, the two-hand operation method is very familiar to many users, and may actually be preferred by some. Thus, it may be desirable to provide a structure for a locking pliers that improves the ability of an operator to adjust the locking pliers, perhaps even with the use of just one hand.

### BRIEF SUMMARY OF SOME EXAMPLES

In an example embodiment, a hand tool may be provided. The hand tool includes a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be configured to enable a grip size defined by the jaw assembly to be modified and includes a first adjuster disposed at a distal end of the top handle, a second adjuster disposed at a point between a middle portion and proximal end of the top handle, and an adjustment rod operably coupled to each of the first and second adjusters and rotatably disposed relative to the top handle to move along a longitudinal axis of the top handle responsive to rotation of either the first adjuster or the second adjuster. The adjustment assembly is operable for two-handed adjustment via the first adjuster and one-handed adjustment via the second adjuster.

In another example embodiment, hand tool may be provided. The hand tool may include a handle assembly comprising a top handle and a bottom handle, a jaw assembly comprising a top jaw and a bottom jaw, and an adjustment assembly. The top and bottom jaws may be operably coupled to the top and bottom handles to compress the top and bottom jaws toward each other responsive to compression of the top and bottom handles toward each other. The adjustment assembly may be configured to enable a grip size defined by the jaw assembly to be modified. The adjustment assembly may include a first adjuster disposed at a distal end of the top handle, a second adjuster disposed at a point between a middle portion and proximal end of the top handle, and an adjustment rod operably coupled to each of the first and second adjusters and rotatably disposed relative to the top handle to move along a longitudinal axis of the top handle responsive to rotation of either the first adjuster or the second adjuster. The second adjuster may include an axial channel formed along a rotational axis thereof. The axial channel may have a cross sectional shape presenting one or more faces that extend along an axial direction. The adjustment rod may include an interface portion configured to receive the axial channel and slidingly engage the second adjuster at the axial channel. The interface portion may include one or more corresponding faces to engage with the one or more faces of the axial channel such that rotation of the second adjuster causes corresponding rotation of the adjustment rod while the adjustment rod moves axially within the axial channel.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a hand tool with an improved adjustment assembly according to an example embodiment;

FIG. 2 is a perspective view of the pliers in cross section according to an example embodiment;

FIG. 3 is a side view of the pliers with a top handle thereof removed to expose internal components and connections according to an example embodiment;

FIG. 4 illustrates an isolated perspective view of internal components the pliers according to an example embodiment;

FIG. 5, which is defined by FIGS. 5A and 5B, illustrates isolated perspective views of the top handle of the pliers according to an example embodiment;

FIG. 6, which is defined by FIGS. 6A, 6B and 6C, shows perspective views of components that form an adjustment assembly for the pliers according to an example embodiment; and

FIG. 7 is a side view of a locking pliers having a clamping assembly according to an example embodiment.

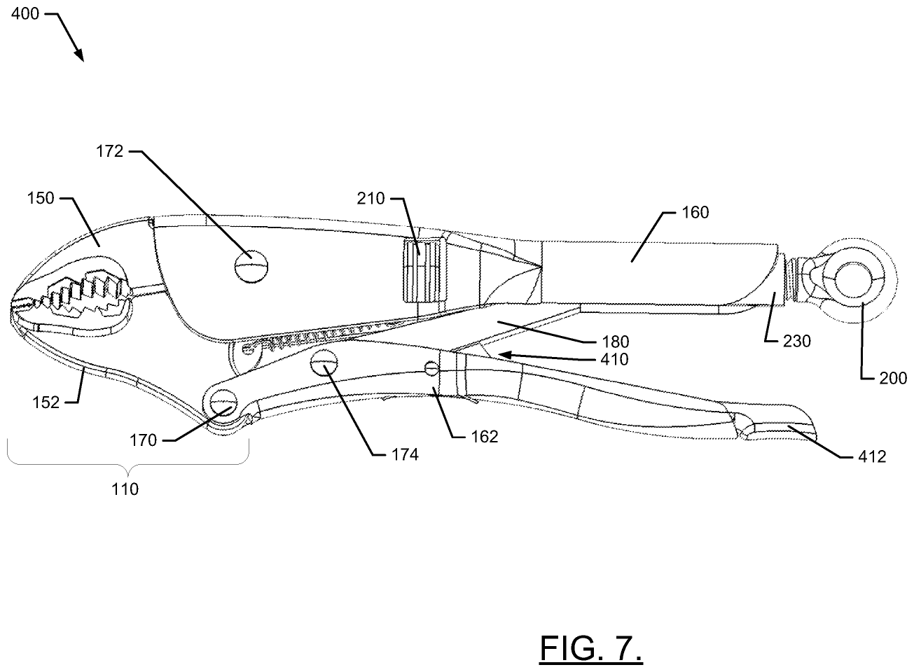

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

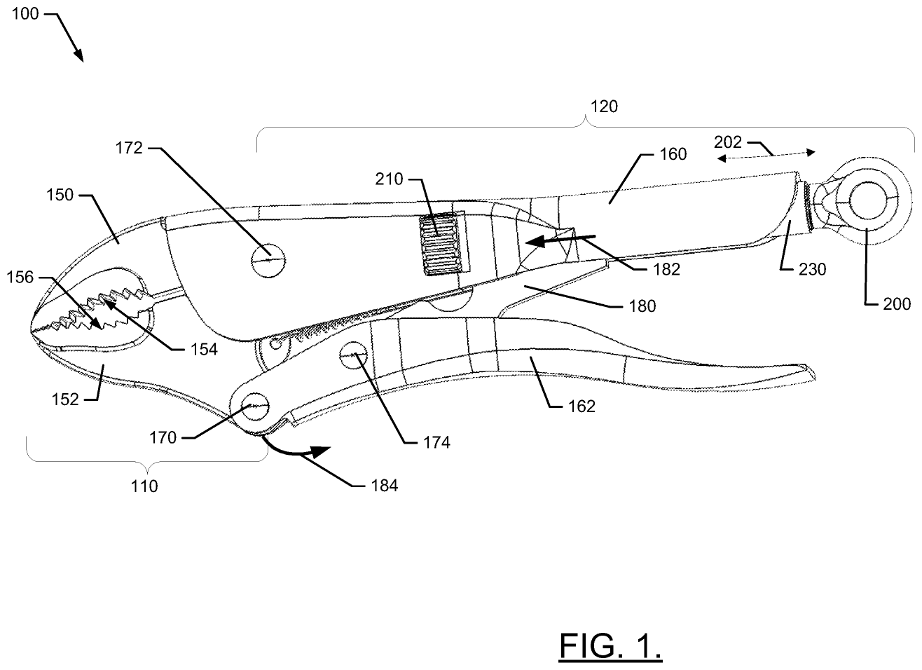

As indicated above, some example embodiments may relate to the provision of a pliers that can be adjusted (i.e., relative to its bite or grip size) more easily, and possibly even with the same hand that is applying a grip to the handles of the pliers. Some example embodiments may provide multiple adjustment options for changing the grip size of the pliers. In this regard, a first adjuster may be disposed at a rear portion (relative to the jaws) of the top handle. Although including the general function of a conventional locking pliers as described above, example embodiments may further include structure for adding another function (e.g., means for hanging the pliers during storage). Meanwhile, a second adjuster may be disposed at an opposite end of a grip portion of the pliers relative to the first adjuster (e.g., proximate to the jaws). FIGS. 1-6 show various views or portions of one example of a pliers capable of grasping media while still being easily adjustable.

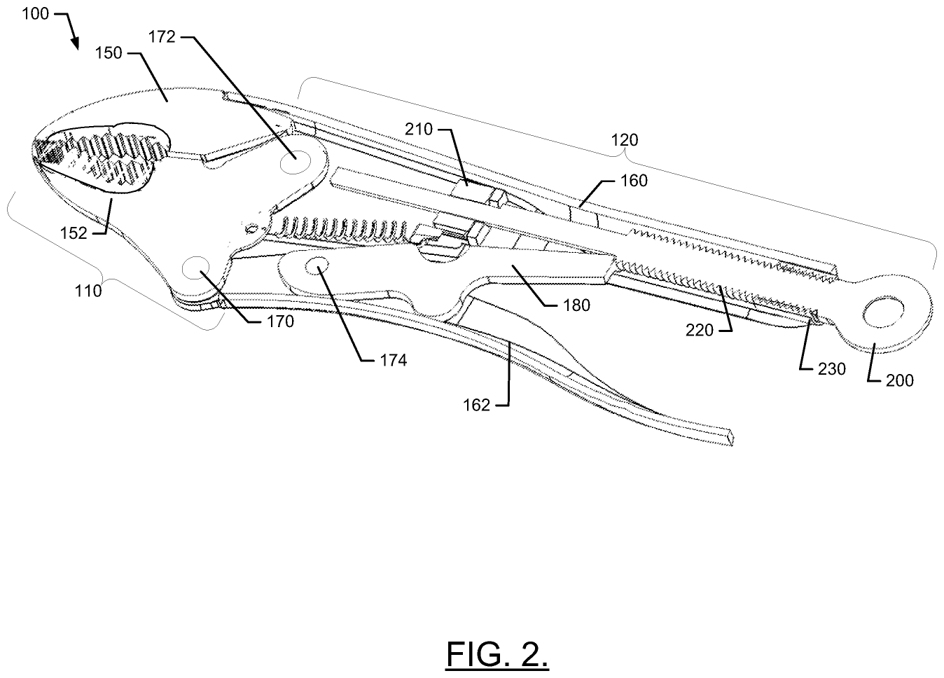

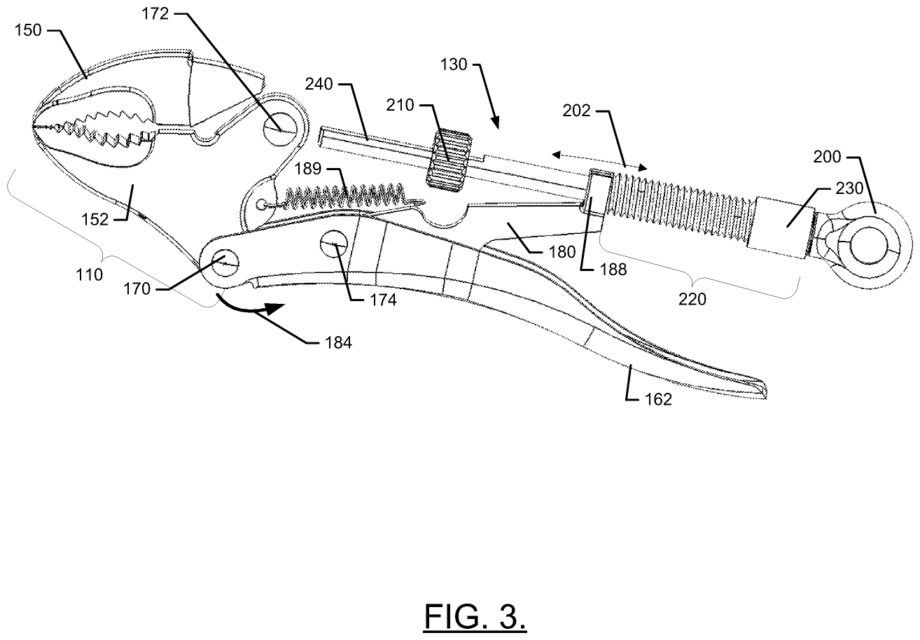

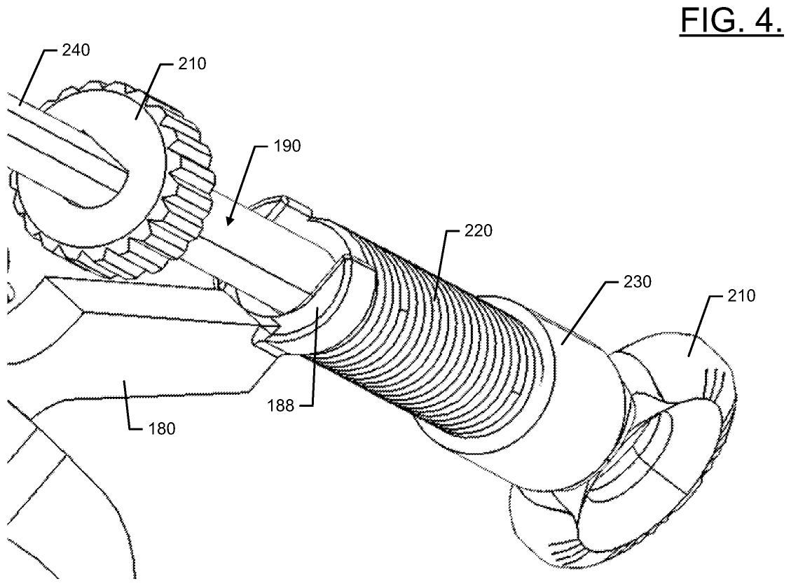

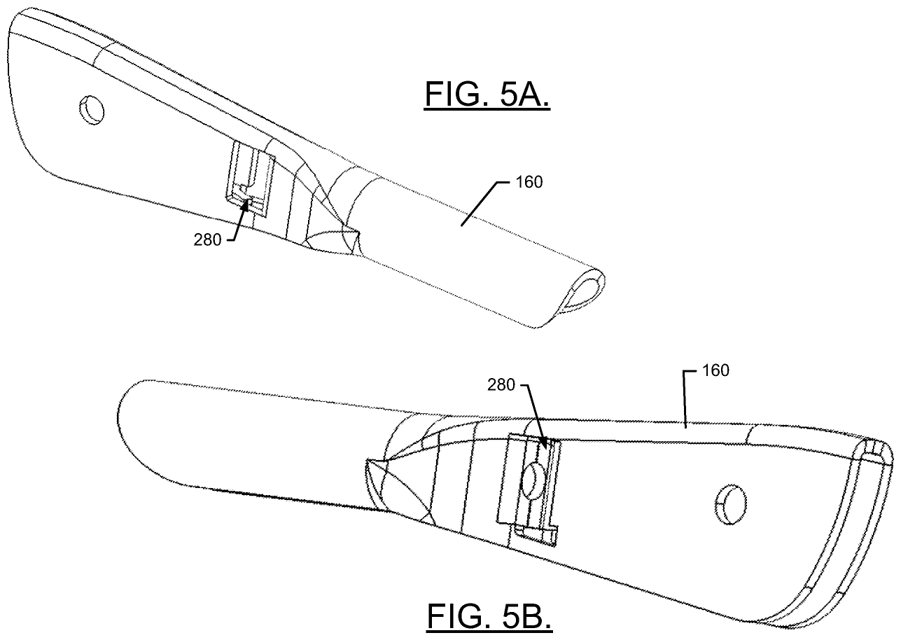

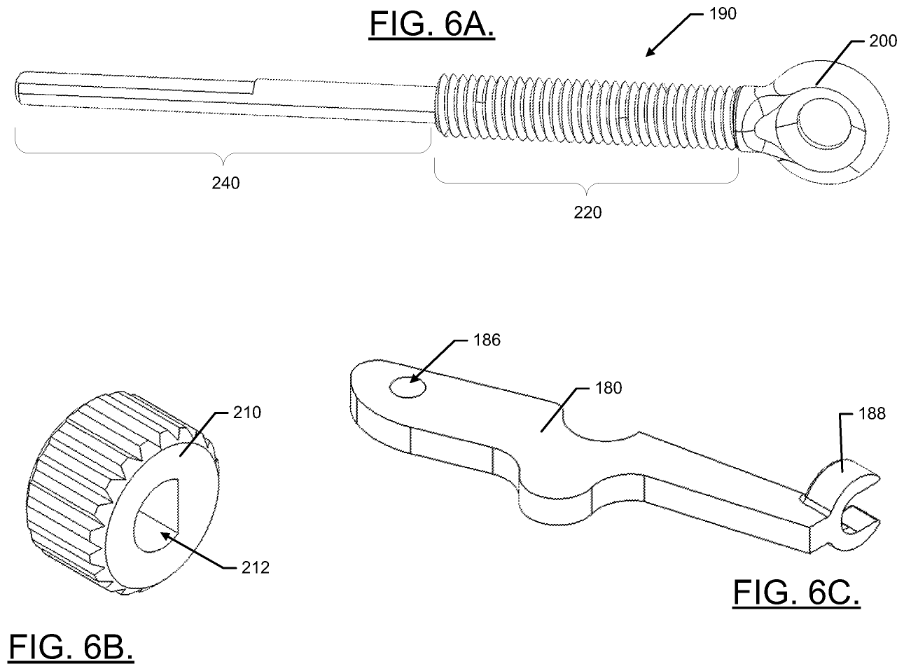

In this regard, FIG. 1 illustrates a side view of a pliers 100 of an example embodiment. FIG. 2 is a perspective view of the pliers 100 in cross section, with the sectioning passing through a longitudinal centerline of the pliers 100 and dividing the pliers 100 into substantially equal right and left halves. The right half is shown in FIG. 2. FIG. 3 is a side view of the pliers with a top handle thereof removed to expose internal components and connections. FIG. 4 illustrates an isolated perspective view of some of those internal components the pliers 100. FIG. 5, which is defined by FIGS. 5A and 5B, illustrates isolated perspective views of the top handle of the pliers 100, and FIG. 6, which is defined by FIGS. 6A, 6B and 6C, shows perspective views of components that form an adjustment assembly for the pliers 100.

Referring now to FIGS. 1-6, the pliers 100 may include a jaw assembly 110 at a first end thereof (e.g., a front end thereof). The pliers 100 may also include a handle assembly 120 at a second end thereof (e.g., a rear end thereof). An adjustment assembly 130 may be integrated into the handle assembly 120 to adjust a grip or bite size of the jaw assembly 110 via one or two handed operation.

The jaw assembly 110 may include a top jaw 150 and a bottom jaw 152 that are configured to face each other with at least one of the top jaw 150 or bottom jaw 152 being movable relative to the other in order to define open and closed positions as defined in greater detail below. Although not required, the top jaw 150 may include an arcuate shaped grip portion 154 that extends from a distal end of the top jaw 150 (relative to the handle assembly 120) toward the handle assembly 120. The grip portion 154 may include transversely extending teeth of similar or different sizes relative to one another. The bottom jaw 152 may also include an arcuate shaped grip portion 156 that extends from a distal end of the bottom jaw 152 (relative to the handle assembly 120). The grip portion 156 may also include transversely extending teeth of similar or different sizes relative to one another (and to the teeth of the grip portion 154 of the top jaw 150). In some cases, the distal ends of the grip portions 154 and 156 may not be arcuate, and may instead be substantially parallel to each other when in the jaw assembly 110 is in the closed position. Media may be placed between the top jaw 150 and bottom jaw 152, and the media may be gripped by the grip portions 154 and 156 via operation of the handle assembly 120.

The handle assembly 120 may include a top handle 160 and a bottom handle 162. In an example embodiment, the handle assembly 120 and the jaw assembly 110, and components thereof, may be pivotally connected to each other via a series of pivot links. For example, the bottom jaw 152 and the bottom handle 162 may be pivotally connected to each other via a first pivot link 170. The top handle 160 and the bottom jaw 152 may be pivotally connected to each other via a second pivot link 172. The top handle 160 and the bottom handle 162 may be operably coupled to each other via a cross link 180. A first end of the cross link 180 may be pivotally connected to the bottom handle 162 at a third pivot link 174, which is disposed at a fixed location on the bottom handle 162. Meanwhile, a second end of the cross link 180 is operably coupled to the top handle 160 at a non-fixed or movable location along the length of the top handle 160. When the handle assembly 120 is compressed (e.g., the top and bottom handles 160 and 162 are compressed toward each other), the pivot links may cooperate to cause the grip portions 154 and 156 of the top and bottom jaws 150 and 152, respectively, to be drawn toward each other. When the handle assembly 120 is released, the top and bottom jaws 150 and 152 may extend apart from each other.

Movement of the variable location at which the cross link 180 intersects with the top handle 160 is accomplished via the adjustment assembly 130, and adjusts the bite or grip size of the jaw assembly 110 by effectively moving an orientation of the first and second pivot links 170 and 172 relative to each other. In this regard, for example, as the location at which the cross link 180 intersects with the top handle 160 moves forward (e.g., in the direction of arrow 182), the first pivot link 170 is moved rearward as shown by arrow 184. The rearward movement of the first pivot link 170 tends to open the top and bottom jaws 150 and 152 relative to each other.

The adjustment assembly 130 may include the cross link 180 and adjustment rod 190, which further comprises a first adjuster 200 and interfaces with a second adjuster 210. Notably, the cross link 180 is not directly connected to the top handle 160 to define the intersection therewith. Instead, the cross link 180 is directly connected to the adjustment rod 190, and the adjustment rod 190 is movable (e.g., in the directions shown by double arrow 202) along the longitudinal axis of the top handle 160 to effectively change the position at which the cross link 180 engages the top handle 160. In this regard, the cross link 180 may include a link receiver 186 at one end thereof, and may include an adjustment rod interface member 188 at the other end thereof. The link receiver 186 may receive the third pivot link 174 to operably couple the cross link to the bottom handle 162. Meanwhile, the adjustment rod interface member 188 may be formed as a U shaped or C shaped retaining member that retains a portion of the adjustment rod 190 therein.

In an example embodiment, the adjustment rod 190 includes a threaded portion 220 that is disposed between the first adjuster 200 and a portion of the adjustment rod 190 that interfaces with the second adjuster 210. The threaded portion 220 is directly connected to a threaded collar 230 that may be a part of, or may be fixedly attached to a distal end of the top handle 160. Accordingly, as can be appreciated from the description above, rotating the first adjuster 200 in one direction causes the adjustment rod 190 to extend further out the distal end of the top handle 160, and rotating the first adjuster 200 in the opposite direction causes the adjustment rod 190 to be drawn into the distal end of the top handle 160.

The first adjuster 200 of this example takes the form of an eyelet. Since the first adjuster 200 is an eyelet, a screw driver or other implement can easily be passed through the eyelet to facilitate turning the first adjuster 200. However, the eyelet also provides an additional functional capability of enabling the pliers 100 to be stored or suspended via the eyelet (e.g., on a hook, nail or other projection).

The adjustment rod interface member 188 may abut a portion of the adjustment rod 190 (in this example, the threaded portion 220). A spring 189 may extend from the bottom jaw 152 to the top handle 160 (proximate to the second adjuster 210) to maintain the adjustment rod interface member 188 firmly in contact with the portion of the adjustment rod 190 that the adjustment rod interface member 188 abuts. As can be appreciated from the description above, as the adjustment rod 190 is rotated to extend further out the distal end of the top handle 160, the second end of the cross link 180 (i.e., the adjustment rod interface member 188) effectively engages (or intersects) the top handle 160 at a portion of the top handle 160 that is closer to the distal end of the top handle 160. Meanwhile, as the adjustment rod 190 is drawn more into the distal end of the top handle 160, the second end of the cross link 180 (i.e., the adjustment rod interface member 188) effectively engages (or intersects) the top handle 160 at a portion of the top handle 160 that is farther from the distal end of the top handle 160. The orientation of the first pivot link 170 relative to the second pivot link 172, and the corresponding changes to bite size described above, are therefore caused by adjusting the position of the adjustment rod 190 relative to the top handle 160 by rotating the first adjuster 200. This causes a corresponding change in the location of the intersection between the adjustment rod interface member 188 along the longitudinal length of the top handle 160 (e.g., along a direction shown by double arrow 202).

Other than the first adjuster 200 being formed as an eyelet to add the additional function of enabling suspension of the pliers 100 via the first adjuster 200, the first adjuster 200 may operate similar to conventional locking pliers. In this regard, a two-hand adjustment of the bite size of the pliers 100 may be caused by operation of the first adjuster 200. However, the addition of the second adjuster 210 adds the further capability of one-hand adjustment and, in any case, allows two different ways by which the grip or bite size of the pliers can be adjusted.

The second adjuster 210 of this example takes the form of a rotatable nut-like actuator that is rotatably captured in a portion of the top handle 160. The second adjuster 210 may therefore, for example, have teeth or other surface features that are relatively easy to grip disposed on an outer peripheral surface thereof. Meanwhile, the second adjuster 210 may also be structured to interface with the adjustment rod 190 to cause the adjustment rod 190 to turn (and therefore move inwardly and outwardly relative to the top handle 160 as described above). In particular, in this example, the second adjuster 210 is formed to have a D shaped channel 212 formed at a center of the second adjuster 210 and extending along a rotational axis of the second adjuster 210. The D shaped channel 212 may be shaped to interface with a non-threaded portion 240 of the adjustment rod 190. The non-threaded portion 240 of the adjustment rod 190 may further include a portion thereof having a D-shaped cross section (taken perpendicular to the axis of the adjustment rod 190) The correspondence of the D shaped channel 212 to the D shaped cross section of the non-threaded portion 240 means that as the second adjuster 210 is turned, the adjustment rod 190 turns in the threaded collar 230 similar to the way adjustment rod 190 turns responsive to turning of the first adjuster 200. Yet, although the adjustment rod 190 turns and moves axially along the longitudinal length of the upper handle 160 (as shown by arrow 202), the D shaped channel 212 slides along the D shaped cross section of the non-threaded portion 240 so that the second adjuster 210 does not move axially along the top handle 160 (instead staying fixed axially and only rotating within a window portion 280 formed in the top handle 160). Moreover, for the particular design shown, there is a 1:1 ratio for turning of the first adjuster 200 and turning of the second adjuster 210. In other words, one turn of the first adjuster 200 is equivalent to one turn of the second adjuster 210, and vice versa.

As an alternative to the design shown, the D shaped cross section of the non-threaded portion 240 could be replaced with a second threaded portion, and the D shaped channel 212 could be replaced with a threaded portion configured to engage the second threaded portion. In such an example, the threads of the second threaded portion could have a different thread count or thread pitch than those of the threaded portion 220. The different thread pitch/count could thereby cause a difference in the ratio between the first and second adjusters 200 and 210. For example, the first adjuster 200 could be configured for coarse adjustment and the second adjuster 210 could be configured for finer adjustment by setting the ratio such that fewer turns of the first adjuster 200 cause more turns of the second adjuster 210. The ratio may therefore be set to 2:1 or 3:1 such that two or three revolutions of the second adjuster 210 correspond to a single revolution of the first adjuster 200. Other strategies for achieving the different ratio may also be employed in some examples.

The second adjuster 210 may more generally be disposed at a point between a middle portion and proximal end of the top handle 160, whereas the first adjuster is disposed at the distal end of the top handle 160 (and at the distal end of the adjustment rod 190). In an example embodiment, the process by which the first and second adjusters 200 and 220 work to turn the adjustment rod 190 may be different, and may operate on different parts of the adjustment rod 190. In this regard, for example, whereas the first adjuster 200 may be fixed to the adjustment rod 190 and movable relative to the top handle 160, the second adjuster 210 may slidingly engage with the adjustment rod 190 to maintain a position of the second adjuster 210 fixed along the length of the top handle 160, but move the position of the second adjuster 210 along the length of the adjustment rod 190 (while still enabling the second adjuster 210 to turn with the adjustment rod 190). Although a D shaped channel is described above, the second adjuster may include an axial channel formed along a rotational axis thereof to have cross sectional shape that can interface with the adjustment rod 190 to slidingly engage along an axial direction, but rigidly fit rotationally (and permit no rotational relative motion). Thus, for example, the axial channel may have one or more faces that extend along an axial direction and the adjustment rod may include an interface portion configured to receive the axial channel and slidingly engage the second adjuster at the axial channel. The interface portion may include one or more corresponding faces to engage with the one or more faces of the axial channel such that rotation of the second adjuster causes corresponding rotation of the adjustment rod while the adjustment rod moves axially within the axial channel.

The window portion 280 formed in the top handle 160 may extend entirely through the sides of the top handle 160, but not the top or bottom. Thus, for example, the window portion 280 extends around four sides of the second adjuster 210, while leaving the other two sides of the second adjuster 210 exposed for operation by the operator. Moreover, the operator can grip the handle assembly 120 while using one finger (e.g., the thumb) to turn the second adjuster 210. Thus, the pliers 100 enables both one-hand operation (e.g., via the second adjuster 210) and two hand operation (e.g., via the first adjuster 200).

The pliers 100 of FIGS. 1-6 is merely one example of a hand tool that may employ example embodiments. In some cases, a locking pliers 400 may employ example embodiments. In this regard, for example, the locking pliers 400 may employ many of the same structures and components of the pliers 100 of FIGS. 1-6, but may further include a clamping assembly 410. The clamping assembly 410 may be configured to enable the top and bottom jaws 150 and 152 to be locked at a selected distance from each other in a locked position. The selected distance may be determined by the adjustment assembly 130 as discussed above. However, when the top and bottom handles 160 and 162 are gripped, the locking of the top and bottom jaws 150 and 152 may only be unlocked by operation of the locking lever 412. In this regard, moving the locking lever 412 in the direction of arrow 414 may unlock the clamping assembly 410.

As can be appreciated from the example of FIGS. 1-6, example embodiments may define a hand tool with an improved capability for grasping media and adjusting the bite size of the jaws with the gripping hand or with two hands. In this regard, for example, a hand tool of an example embodiment may include a handle assembly, a jaw assembly, and an adjustment assembly. The handle assembly may include a top handle and a bottom handle. The jaw assembly may include a top jaw and a bottom jaw. The top and bottom jaws may be operably coupled to the top and bottom handles to compress the top and bottom jaws toward each other responsive to compression of the top and bottom handles toward each other. The adjustment assembly may be configured to enable a grip size defined by the jaw assembly to be modified and includes a first adjuster disposed at a distal end of the top handle, a second adjuster disposed at a point between a middle portion and proximal end of the top handle, and an adjustment rod operably coupled to each of the first and second adjusters and rotatably disposed relative to the top handle to move along a longitudinal axis of the top handle responsive to rotation of either the first adjuster or the second adjuster. The adjustment assembly is operable for two-handed adjustment via the first adjuster and one-handed adjustment via the second adjuster.

The hand tool and/or its components may include a number of modifications, augmentations, or optional additions, some of which are described herein. The modifications, augmentations or optional additions may be added in any desirable combination. For example, the first adjuster may include an eyelet from which the hand tool is suspendable for hanging storage. In an example embodiment, the adjustment assembly may further include a cross link extending from the bottom handle to the adjustment rod. In some cases, the cross link may be operably coupled to the adjustment rod at a fixed location on the adjustment rod, and the fixed location may move relative to the top handle responsive to rotation of the adjustment rod. In an example embodiment, the first adjuster may extend off the distal end of the top handle and alternately gets closer to and farther away from the top handle responsive to rotation of the adjustment rod. In some cases, the second adjuster may be disposed in a window portion formed in the top handle, and the window portion may extend around four sides of the second adjuster leaving two remaining sides of the second adjuster exposed for operation by a user. In an example embodiment, the adjustment rod may include a threaded portion in threaded engagement with a threaded collar disposed at the distal end of the top handle, and a non-threaded portion configured to interface with the second adjuster. Rotation of the first adjuster and the second adjuster may each cause corresponding rotation of the adjustment rod with a 1:1 ratio. In some cases, the second adjuster includes a D shaped channel formed along a rotational axis thereof, and the non-threaded portion of the adjustment rod includes a D shaped cross section configured to slidingly engage the D shaped channel such that rotation of the second adjuster causes corresponding rotation of the adjustment rod while the adjustment rod moves axially within the D shaped channel. In an example embodiment, the first adjuster may be disposed at a first end of the adjustment rod, the second adjuster may interface with a second end of the adjustment rod, and interface mechanisms between the adjustment rod and the first and second adjusters may be different. In some cases, rotation of the first adjuster and the second adjuster may cause corresponding rotation of the adjustment rod with a ratio that is not 1:1. In an example embodiment, the hand tool further includes a clamping assembly configured to enable the top and bottom jaws to be locked at a selected distance from each other in a locked position, the selected distance being determined by the adjustment assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other; and
an adjustment assembly configured to enable a grip size defined by the jaw assembly to be modified,
wherein the adjustment assembly comprises a first adjuster disposed at a distal end of the top handle, a second adjuster disposed at a point between a middle portion and proximal end of the top handle, and an adjustment rod operably coupled to each of the first and second adjusters and rotatably disposed relative to the top handle to move along a longitudinal axis of the top handle responsive to rotation of either the first adjuster or the second adjuster, and
wherein the adjustment assembly is operable for two-handed adjustment via the first adjuster and one-handed adjustment via the second adjuster.

2. The hand tool of claim 1, wherein the first adjuster comprises an eyelet from which the hand tool is suspendable for hanging storage.

3. The hand tool of claim 1, wherein the adjustment assembly further comprises a cross link extending from the bottom handle to the adjustment rod.

4. The hand tool of claim 3, wherein the cross link is operably coupled to the adjustment rod at a fixed location on the adjustment rod, and
wherein the fixed location moves relative to the top handle responsive to rotation of the adjustment rod.

5. The hand tool of claim 4, wherein the first adjuster extends off the distal end of the top handle and alternately gets closer to and farther away from the top handle responsive to rotation of the adjustment rod.

6. The hand tool of claim 5, wherein the second adjuster is disposed in a window portion formed in the top handle, and
wherein the window portion extends around four sides of the second adjuster and leaves two remaining sides of the second adjuster exposed for operation by a user.

7. The hand tool of claim 1, wherein the adjustment rod comprises a threaded portion in threaded engagement with a threaded collar disposed at the distal end of the top handle, and a non-threaded portion configured to interface with the second adjuster, and
wherein rotation of the first adjuster and the second adjuster each cause corresponding rotation of the adjustment rod with a 1:1 ratio.

8. The hand tool of claim 7, wherein the second adjuster includes a D shaped channel formed along a rotational axis thereof, and
wherein the non-threaded portion of the adjustment rod includes a D shaped cross section configured to slidingly engage the D shaped channel such that rotation of the second adjuster causes corresponding rotation of the adjustment rod while the adjustment rod moves axially within the D shaped channel.

9. The hand tool of claim 7, wherein the first adjuster is disposed at a first end of the adjustment rod,
wherein the second adjuster interfaces with a second end of the adjustment rod, and
wherein interface mechanisms between the adjustment rod and the first and second adjusters are different.

10. The hand tool of claim 1, wherein rotation of the first adjuster and the second adjuster cause corresponding rotation of the adjustment rod with a ratio that is not 1:1.

11. The hand tool of claim 1, further comprising a clamping assembly configured to enable the top and bottom jaws to be locked at a selected distance from each other in a locked position, the selected distance being determined by the adjustment assembly.

12. A hand tool comprising:
a handle assembly comprising a top handle and a bottom handle;
a jaw assembly comprising a top jaw and a bottom jaw, the top and bottom jaws being operably coupled to the top and bottom handles to compress the top and bottom jaws toward each other responsive to compression of the top and bottom handles toward each other; and
an adjustment assembly configured to enable a grip size defined by the jaw assembly to be modified,
wherein the adjustment assembly comprises a first adjuster disposed at a distal end of the top handle, a second adjuster disposed at a point between a middle portion and proximal end of the top handle, and an adjustment rod operably coupled to each of the first and second adjusters and rotatably disposed relative to the top handle to move along a longitudinal axis of the top handle responsive to rotation of either the first adjuster or the second adjuster,
wherein the second adjuster includes an axial channel formed along a rotational axis thereof, the axial channel having a cross sectional shape presenting one or more faces that extend along an axial direction, and
wherein the adjustment rod comprises an interface portion configured to receive the axial channel and slidingly engage the second adjuster at the axial channel, the interface portion including one or more corresponding faces to engage with the one or more faces of the axial channel such that rotation of the second adjuster causes corresponding rotation of the adjustment rod while the adjustment rod moves axially within the axial channel.

13. The hand tool of claim 12, wherein the first adjuster comprises an eyelet from which the hand tool is suspendable for hanging storage.

14. The hand tool of claim 12, wherein the adjustment assembly further comprises a cross link extending from the bottom handle to the adjustment rod.

15. The hand tool of claim 14, wherein the cross link is operably coupled to the adjustment rod at a fixed location on the adjustment rod, and
wherein the fixed location moves relative to the top handle responsive to rotation of the adjustment rod.

16. The hand tool of claim 15, wherein the first adjuster extends off the distal end of the top handle and alternately gets closer to and farther away from the top handle responsive to rotation of the adjustment rod.

17. The hand tool of claim 16, wherein the second adjuster is disposed in a window portion formed in the top handle, and
wherein the window portion extends around four sides of the second adjuster and leaves two remaining sides of the second adjuster exposed for operation by a user.

18. The hand tool of claim 12, wherein the adjustment rod comprises a threaded portion in threaded engagement with a threaded collar disposed at the distal end of the top handle, and a non-threaded portion defining the interface portion.

19. The hand tool of claim 12, wherein the first adjuster is disposed at a first end of the adjustment rod,
wherein the second adjuster interfaces with a second end of the adjustment rod, and
wherein interface mechanisms between the adjustment rod and the first and second adjusters are different.

20. The hand tool of claim 12, further comprising a clamping assembly configured to enable the top and bottom jaws to be locked at a selected distance from each other in a locked position, the selected distance being determined by the adjustment assembly.
